(19) United States
(12) Patent Application Publication
(10) Pub. No.: US 2025/0141879 A1
(43) Pub. Date: May 1, 2025

(54) System and method for implementing location-based validation in data item transfer approval process

(71) Applicant: Bank of America Corporation, Charlotte, NC (US)

(72) Inventors: Abhijit Behera, Telangana (IN); Gowri Sundar Suriyanarayanan, Tamilnadu (IN); Maneesh Kumar Sethia, Telangana (IN); Shailendra Singh, Maharashtra (IN)

(21) Appl. No.: 18/496,361

(22) Filed: Oct. 27, 2023

(51) Int. Cl. H04L 9/40; H04L 67/52

(52) U.S. Cl. CPC H04L 63/107; H04L 67/52

(57) ABSTRACT

A system for implementing location-based validation in data item transfer approval is disclosed. The system receives a request message that indicates to transfer a data item. The system determines a first location data indicating where a sender has registered to a software application configured to facilitate transferring the data item and a second location data indicating a current location of the sender. The system determines a third location data indicating where a receiver has registered to the software application and a fourth location data indicating a current location of the receiver. The system determines whether the request message is anomalous based at least on rules. Each rule indicates a circumstance that a data item transfer request is to be approved or denied based on location data associated with a sender and a receiver. The system grants the request message if it is determined that the request message is not anomalous.

### TECHNICAL FIELD

The present disclosure relates generally to information security, and more specifically to a system and method for implementing location-based validation in data item transfer approval process.

### BACKGROUND

People use devices to communicate different kinds of data items to other people. Some data item transfers originate from locations that are known to be unauthorized locations to transfer data items. Some data items may originate from authorized locations but are requested to be sent to unauthorized locations. Some data item transfers are originated by authorized users. Some data item transfers are requested to be sent to users who are unauthorized to receive data items.

### SUMMARY

The disclosed system described in the present disclosure is particularly integrated into a practical application of increasing the safety and security in transferring and receiving data items and reducing fraudulent activities with respect to transferring and receiving data items through a network. In the current data item transfer systems, the data item transfer request may be initiated from any location (e.g., country). However, certain locations may be under international regulatory constraints which state that certain locations are not allowed to send or receive data items. Therefore, the current data item transfer systems lack the implementation to validate whether a request for transferring data items is initiated from within such locations and whether the data item is going to be received in such locations. For example, the current data item transfer system lacks a validation process for validating the origin location associated with the sender and receiver of the data items.

The present disclosure contemplates an unconventional system and method for implementing a location-based verification in the data item transfer approval process. For example, in some embodiments, the disclosed system is configured to determine the onboarding location of a sender of a data item, a current location of the user device of the sender from which the sender initiates the transfer request, an onboarding location of a receiver of the data item, and a current location where the user device of the receiver is located. These four pieces of location data are used to determine the source and destination of the data item. Therefore, the disclosed system is configured to determine whether: 1) the sender is authorized to transfer the data item (based on the onboarding location data where the sender has registered to open a profile in a software application configured to transfer the data item), 2) the sender is initiating the transfer request from a location that is under data item transfer regulatory constraints (based on the location data where the sender initiates the transfer request), 3) the receiver is authorized to receive the data item (based on the onboarding location data where the receiver has registered to open a profile in the software application), and 4) the user device of the receiver is located in a location that is under data item transfer regulatory constraints. In this manner, the disclosed system is configured to validate the source and destination of the data item and determine whether to grant or deny the transfer request 104.

Accordingly, the disclosed system improves the security of data item transfers via the network. For example, by implementing the disclosed system which includes validating whether the sender is authorized to transfer the data item, validating whether the location where the transfer request is initiated is an authorized location, validating whether the receiver is authorized to receive the data item, and validating whether the location where the user device is located is an authorized location, bad actors cannot send or receive data items from any location, whether from a location that is under data item transfer regulatory constraints or not. Furthermore, the disclosed system is configured to determine the patterns of historical data item transfers and determine whether the determined patterns are anomalous. If it is determined that the historical transfers of the data items received from the sender are anomalous, the disclosed system may deny subsequent transfer requests from the sender. In this way, the security of data item transfers is increased and fraudulent activities with respect to sending and receiving data items are reduced.

Furthermore, the disclosed system reduces the processing, memory, and network resources of the nodes by reducing the number of application programming interface (API) calls provisioned to be sent to determine the respective location data. By obtaining each location data at key stages during the validation process, the disclosed system reduces extensive API calls and network traffic which leads to decreasing the network load and usage for the nodes and user devices. Furthermore, the disclosed system reduces the processing, memory and network resources of the nodes by identifying and processing permissible data item transfer requests and avoiding processing of non-compliant data item transfer requests. This, in turn, leads to a reduction in the amount of data that needs to be stored and analyzed. Furthermore, the disclosed system improves the data item transfer validation process by implementing a deep learning algorithm that is configured to identify unusual and anomalous data transfer requests based on the rules and a training dataset that includes historical data transfers, each labeled with approved, denied, or a warning alert indication.

In some embodiments, a system for implementing location-based validation in the data item transfer approval process comprises a processor operably coupled to a memory. The memory is configured to store a training dataset that comprises a set of historical data item transfers, each of the set of historical data item transfers is labeled with a granted or denied indication and a set of rules, each of the set of rules indicates a circumstance that a data item transfer request is to be approved or denied based at least in part upon location data associated with a sender and a receiver of a respective data item. The processor is configured to receive a request message that indicates to transfer a data item. The processor is further configured to determine a first location data associated with a sender of the data item, wherein the first location data indicates a location where the sender is registered to a software application that is configured to facilitate transferring the data item. The processor is further configured to determine a second location data associated with the sender of the data item, wherein the second location data indicates a current location of a first user device from which the request message is received. The processor is further configured to determine a third location data associated with a receiver of the data item, wherein the third location data indicates a location where the receiver has registered to the software application. The processor is further configured to determine a fourth location data associated with the receiver of the data item, wherein the fourth location data indicates a current location of a second user device associated with the receiver. The processor is further configured to determine whether the request message is anomalous based at least in part upon the training dataset and the set of rules. In response to determining that the request message is not anomalous, the processor is further configured to grant the request message.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to implement location-based validation in data item transfer approval process;

FIG. 2 illustrates an example operational flow of the system of FIG. 1; and

FIG. 3 illustrates an example flowchart of a method to implement location-based validation in data item transfer approval process.

### DETAILED DESCRIPTION

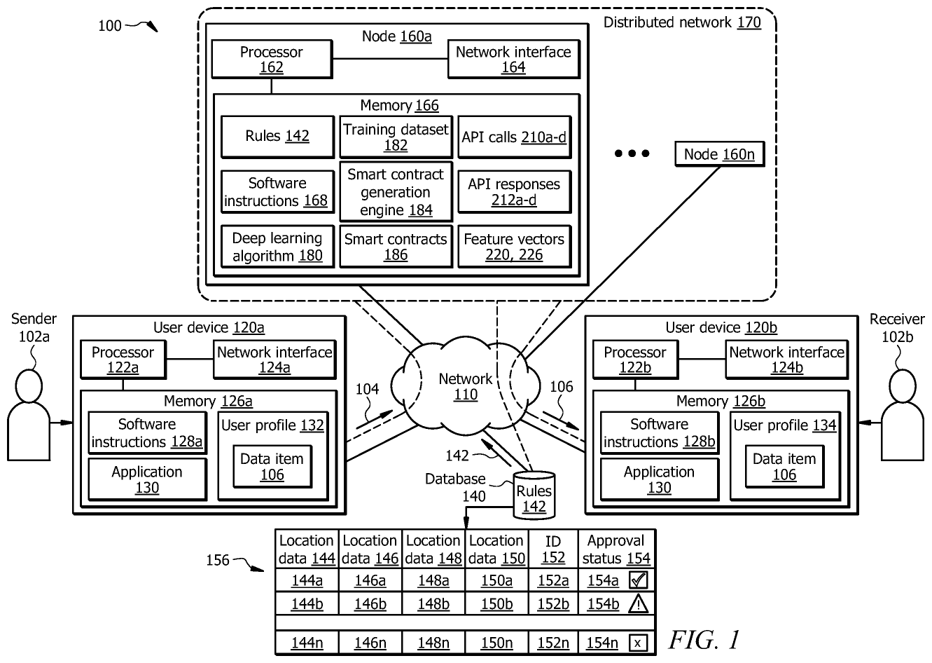

As described above, previous technologies fail to provide efficient and reliable solutions to implement location-based validation in data item transfer approval process. Embodiments of the present disclosure and its advantages may be understood by referring to FIGS. 1 through 3. FIGS. 1 through 3 are used to describe systems and methods to implement location-based validation in data item transfer approval process, according to some embodiments.

### System Overview

FIG. 1 illustrates an embodiment of a system 100 that is generally configured to increase the security in transferring data items 106 and reducing fraudulent activities with respect to transferring and receiving data items 106 through a network 110. In some embodiments, the system 100 comprises one or more user devices 120a and 120b, a database 140, and a distributed network 170, communicatively coupled to each other via a network 110. Network 110 enables communication among the components of the system 100. The user 102a may use the user device 120a to initiate a request to transfer a data item 106. Thus, user 102a may be referred to as a sender 102a. The user 102b may use the user device 120b to receive the data item. Thus, user 102b may be referred to as a receiver 102b. The distributed network 170 comprises a cluster of nodes 160a through 160n. In other embodiments, system 100 may not have all of the components listed and/or may have other elements instead of, or in addition to, those listed above.

In general, the system 100 enhances the safety and security in transferring and receiving data items 106 via the network 110, implements a process to validate an origin location where a request to transfer the data item 106 is initiated, implements a process to validate a destination where the data item 106 is going to be received and reduces processing, memory, and network resources that otherwise would be spent on evaluating and conducting anomalous data item transfers.

In the current data item transfer systems, the data item transfer request may be initiated from any location (e.g., country). However, certain locations may be under international regulatory constraints which state that certain locations are not allowed to send or receive data items 106. Therefore, the current data item transfer systems lack the implementation to validate whether a request 104 for transferring data item 106 is initiated from within such locations and whether data item 106 is going to be received in such locations. For example, the current data item transfer system lacks a validation process for validating the origin location associated with sender 102a and receiver 102b of the data items 106.

The present disclosure contemplates an unconventional system and method for implementing a location-based verification in the data item transfer approval process. For example, in some embodiments, the disclosed system 100 is configured to determine an onboarding location of a sender 102a of a data item 106, a current location of the user device 120a of the sender 102a from which the sender 102a initiates the transfer request 104, an onboarding location of a receiver 102b of the data item 106, and a current location where the user device 120b of the receiver 102b is located. These four pieces of location data are used to determine the source and destination of the data item 106. Therefore, the disclosed system 100 is configured to determine whether: 1) the sender 102a is authorized to transfer the data item 106 (based on the onboarding location data 144 where the sender 102a has registered to open a profile in the application 130), 2) the sender 102a is initiating the transfer request 104 from a location that is under data item transfer regulatory constraints (based on the location data 146 where the sender 102a initiates the transfer request 104), 3) the receiver 102b is authorized to receive the data item 106 (based on the onboarding location data 146 where the receiver 102b has registered to open a profile in the application 130), and 4) the user device 120b of the receiver 102b is located in a location that is under data item transfer regulatory constraints (based on the location data 150). In this manner, the disclosed system 100 is configured to validate the source and destination of the data item 106 and determine whether to grant or deny the transfer request 104.

Accordingly, the disclosed system 100 improves the security of data item transfers via network 110. For example, by implementing the disclosed system 100 which includes validating whether the sender 102a is authorized to transfer the data item 106, validating whether the location where transfer request 104 is initiated is an authorized location, validating whether the receiver 102b is authorized to receive the data item 106, and validating whether the location where the user device 120b is located is an authorized location, bad actors cannot send or receive data items 106 from any location, whether from a location that is under data item transfer regulatory constraints or not. Furthermore, the disclosed system 100 is configured to determine the patterns of historical data item transfers and determine whether the determined patterns are anomalous. If it is determined that the historical transfers of the data item 106 received from the sender 102a is anomalous, the disclosed system 100 may deny subsequent transfer requests from the sender 102a. In this way, the security of data item transfers is increased and fraudulent activities with respect to sending and receiving data items 106 are reduced.

Furthermore, the disclosed system 100 reduces the processing, memory, and network resources of the nodes 160a-n by reducing the number of application programming interface (API) calls provisioned to be sent to determine the location data 144, 146, 148, and 150. By obtaining each location data 144, 146, 148, and 150 at key stages during the validation process, the system 100 reduces extensive API calls and network traffic which leads to decreasing the network load and usage for the nodes 160a-n and user devices 120a-b. Furthermore, the disclosed system 100 reduces the processing, memory, and network resources of the nodes 160a-n by identifying and processing permissible data item transfer requests 104 and avoiding processing non-compliant data item transfer requests 104. This, in turn, leads to a reduction in the amount of data that needs to be stored and analyzed. Furthermore, the disclosed system 100 improves the data item transfer validation process by implementing a deep learning algorithm that is configured to identify unusual and anomalous data transfer requests 104 based on the rules 142 and a training dataset that includes historical data transfers, each labeled with approved, denied, or a warning alert indication.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may be configured to support any suitable type of communication protocol as would be appreciated by one of ordinary skill in the art.

### Example User Device

Each of the user devices 120a and 12b is an instance of a user device 120. The user device 120 may be generally any device that is configured to process data and interact with users 102a-b. Examples of the user device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The user device 120 may include a user interface, such as a display, a microphone, a camera, keypad, or other appropriate terminal equipment usable by user 102a-b. The user device 120 may include a hardware processor, memory, and/or circuitry configured to perform any of the functions or actions of the user device 120 described herein. In the present disclosure, the user device 120 may be interchangeably referred to as a computing device.

The user device 120a includes a processor 122a in signal communication with a network interface 124a and a memory 126a. The memory 126a stores software instructions 128a that when executed by the processor 122a cause the processor 122a to perform one or more operations of the user device 120a described herein. The user device 120a is configured to communicate with other devices and components of the system 100 via the network 110. The user device 120a may be associated with the user 102a (also referred to herein as a sender). The user device 120a may be used to initiate a request 104 to transfer a data item 106. The request 104 may be packaged in a data packet, a message, or a data transmission.

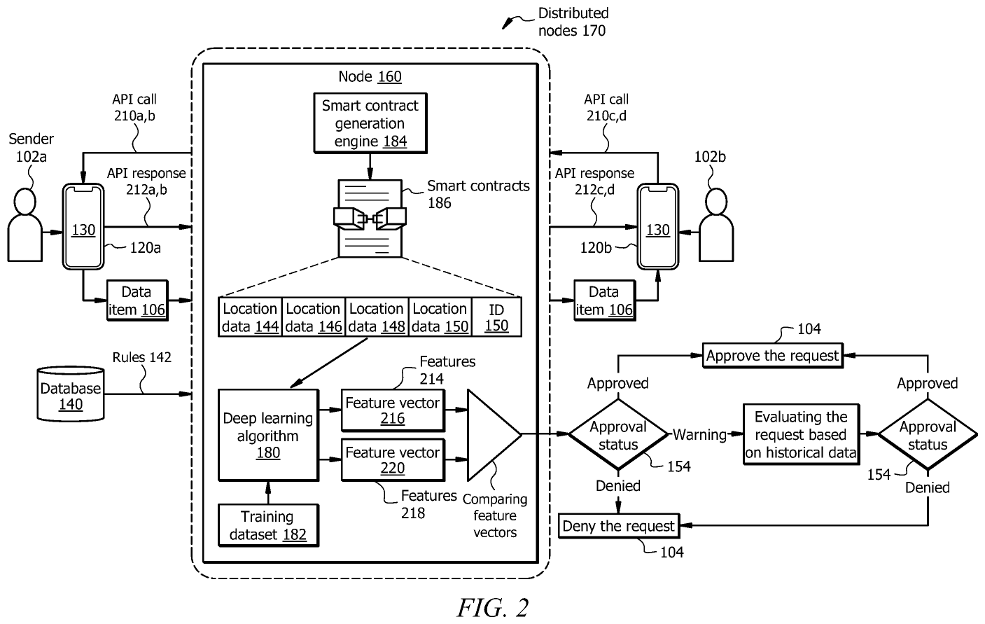

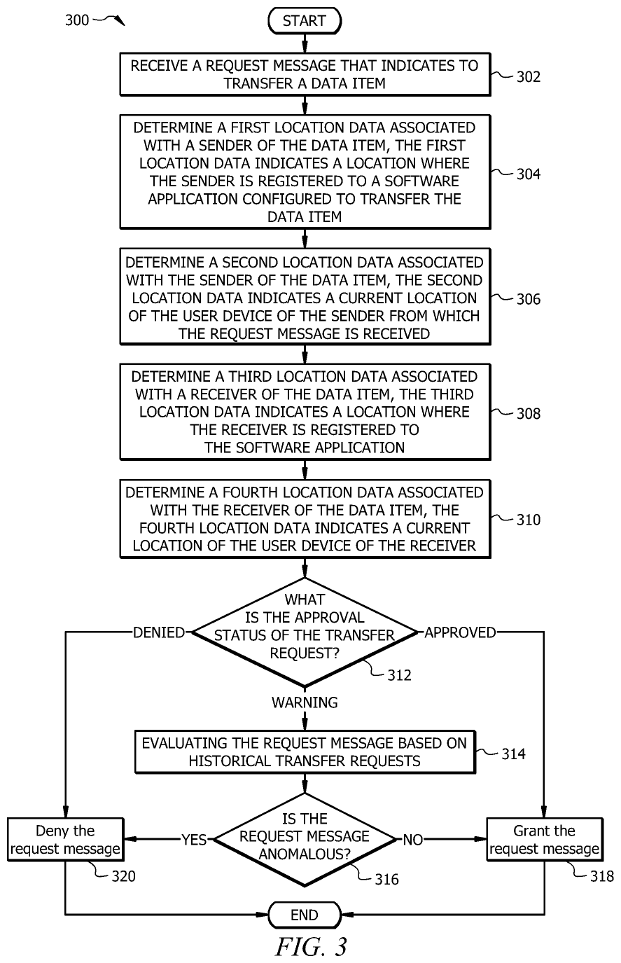

Processor 122a comprises one or more processors. The processor 122a is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 122a may be a programmable logic device, a microcontroller, a microprocessor, or any suitable number and combination of the preceding. The one or more processors are configured to process data and may be implemented in hardware or software. For example, the processor 122a may be 8-bit, 16-bit, 32-bit, 64-bit, or of any other suitable architecture. The processor 122a may include an arithmetic logic unit (ALU) for performing arithmetic and logic operations. The processor 122a may register the supply operands to the ALU and store the results of ALU operations. The processor 122a may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128a) to perform the operations of the node 160 described herein. In this way, processor 122a may be a special-purpose computer designed to implement the functions disclosed herein. In an embodiment, the processor 122a is implemented using logic units, FPGAs, ASICs, DSPs, or any other suitable hardware. The processor 122a is configured to operate as described in FIGS. 1-3. For example, the processor 122a may be configured to perform one or more operations of the operational flow 200 as described in FIG. 2, and one or more operations of the method 300 as described in FIG. 3.

Network interface 124a is configured to enable wired and/or wireless communications. The network interface 124a may be configured to communicate data between the user device 120a and other devices, systems, or domains. For example, the network interface 124a may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122a may be configured to send and receive data using the network interface 124a. The network interface 124a may be configured to use any suitable type of communication protocol.

The memory 126a may be a non-transitory computer-readable medium. The memory 126a may be volatile or non-volatile and may comprise read-only memory (ROM), random-access memory (RAM), ternary content-addressable memory (TCAM), dynamic random-access memory (DRAM), and/or static random-access memory (SRAM). The memory 126a may include one or more of a local database, a cloud database, a network-attached storage (NAS), etc. The memory 126a comprises one or more disks, tape drives, or solid-state drives, and may be used as an over-flow data storage device, to store programs when such programs are selected for execution, and to store instructions and data that are read during program execution. The memory 126a may store any of the information described in FIGS. 1-3 along with any other data, instructions, logic, rules, or code operable to implement the function(s) described herein when executed by processor 122a. For example, the memory 126a may store software instructions 128a, application 130, user profile 132, and/or any other data or instructions described herein. The software instructions 128a may comprise any suitable set of instructions, logic, rules, or code operable to execute the processor 122a and perform the functions described herein, such as some or all of those described in FIGS. 1-3.

The application 130 may be a software, web, or mobile application. The application 130 may be associated with the organization to which the nodes 160 are associated. The application 130 may provide an interface for the user 102a to interact with the application 130 to provide input to the user device 120a. For example, the application 130 may include interfaces to access the user profile 132 where an identification of the data item 106 may be stored. When user 102a wants to initiate a request to transfer the data item 106, the user 102a may access the user profile 132 from the application 130 and indicate they want to transfer the data item 106. The user profile 132 may include data items 106 and/or their identifiers. In some examples, the data item 106 may include a file, a document, cryptocurrency, and data object, among others. In some embodiments, the user profile 132 may include or be associated with a digital wallet of the user 102a. In some embodiments, the user profile 132 may be in a file directory where the data items 106 and/or files, documents, media files, and the like may be stored. In some embodiments, the user profile 132 may store any information related to the user 102a, including a name, address, etc.

The user device 120b includes a processor 122b in signal communication with a network interface 124b and memory 126b. Memory 126b stores software instructions 128b that when executed by the processor 122b cause the processor 122b to perform one or more operations of the user device 120b. The user device 120b may be associated with the user 102a (also referred to herein as a sender 102a). The user device 120b may be used to receive the data item 106.

Processor 122b comprises one or more processors. The processor 122b is any electronic circuitry, including, but not limited to, state machines, one or more CPU chips, logic units, cores (e.g., a multi-core processor), FPGAs, ASIC), or DSPs. For example, one or more processors may be implemented in cloud devices, servers, virtual machines, and the like. The processor 122b may be a programmable logic device, a microcontroller, a microprocessor, or any suitable number and combination of the preceding. The one or more processors are configured to process data and may be implemented in hardware or software. For example, the processor 122b may be 8-bit, 16-bit. 32-bit, 64-bit, or of any other suitable architecture. The processor 122b may include an ALU for performing arithmetic and logic operations. The processor 122b may register the supply operands to the ALU and store the results of ALU operations. The processor 122b may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128b) to perform the operations of the node 160 described herein. In this way, processor 122b may be a special-purpose computer designed to implement the functions disclosed herein. In an embodiment, the processor 122b is implemented using logic units, FPGAs, ASICs, DSPs, or any other suitable hardware. The processor 122b is configured to operate as described in FIGS. 1-3. For example, the processor 122b may be configured to perform one or more operations of the operational flow 200 as described in FIG. 2, and one or more operations of the method 300 as described in FIG. 3.

Network interface 124b is configured to enable wired and/or wireless communications. The network interface 124b may be configured to communicate data between the user device 120b and other devices, systems, or domains. For example, the network interface 124b may comprise an NFC interface, a Bluetooth interface, a Zigbee interface, a Z-wave interface, an RFID interface, a WIFI interface, a LAN interface, a WAN interface, a MAN interface, a PAN interface, a WPAN interface, a modem, a switch, and/or a router. The processor 122b may be configured to send and receive data using the network interface 124b. The network interface 124b may be configured to use any suitable type of communication protocol.

The memory 126b may be a non-transitory computer-readable medium. The memory 126b may be volatile or non-volatile and may comprise ROM, RAM, TCAM, DRAM, and/or SRAM. The memory 126b may include one or more of a local database, a cloud database, a NAS, etc. The memory 126b comprises one or more disks, tape drives, or solid-state drives, and may be used as an over-flow data storage device, to store programs when such programs are selected for execution, and to store instructions and data that are read during program execution. The memory 126b may store any of the information described in FIGS. 1-3 along with any other data, instructions, logic, rules, or code operable to implement the function(s) described herein when executed by processor 122b. For example, the memory 126b may store software instructions 128b, application 130, user profile 134, and/or any other data or instructions. The software instructions 128b may comprise any suitable set of instructions, logic, rules, or code operable to execute the processor 122b and perform the functions described herein, such as some or all of those described in FIGS. 1-3.

The application 130 may be used to provide an interface for the user 102b to interact with the application 130. For example, when the user 102b wants to receive the data item 106, they may access the application 130 and initiate a request to receive the data item 106. In some embodiments, the user profile 134 may include or be associated with a digital wallet of the user 102b. In some embodiments, the user profile 134 may be at a directory where the data items 106 and/or files, documents, media files, and the like may be stored. In some embodiments, the user profile 132 may store any information related to the user 102a, including a name, address, etc.

### Database

The database 140 may be any storage capacity structure that is configured to store data and communicate with other devices. Examples of the database 140, include, but are not limited to, a network-attached storage cloud, a storage area network, a storage assembly directly (or indirectly) coupled to one or more components of the system 100. The database 140 stores rules 142. The rules 142 generally indicate different scenarios of different combinations of location data 144, 146, 148, and 150. For example, each rule 142 may indicate a circumstance that a data transfer request 104 is to be approved, denied, or needs further evaluation (indicated by a warning alert) based on the location data 144 and 146 associated with the sender 102a of the data item 106 and location data 148 and 150 associated with the receiver 102b of the data item 106.

The set of rules 142 may be indicated in the table format, where each row of the table 156 is for a different rule 142. For example, the first row in the table shown in FIG. 1 may indicate a first rule 142 that if 1) the onboarding location data 144a associated with the sender 102a indicates that the sender 102a has registered on the application 130 in an authorized location (e.g., country), 2) the current location of the user device 120a of the sender 102a (i.e., location data 146a) is or within an authorized location to make the transfer, 3) the onboarding location data 148a associated with the receiver 102b indicates that the receiver 102b has registered on the application 130 in an authorized location (e.g., country), and 4) the current location of the user device 120b of the receiver 102b (location data 150a) is or within an authorized location to receive the data item 106, the data item transfer request 104 is to be approved (as indicated by the approval status 154a).

In another example, the second row in the table 156 shown in FIG. 1 may indicate a second rule 142 that if 1) the onboarding location data 144b associated with the sender 102a indicates that the sender 102a has registered on the application 130 in an authorized location (e.g., country), 2) the current location of the user device 120a of the sender 102a (i.e., location data 146b) is or within an authorized location to make the transfer, 3) the onboarding location data 148b associated with the receiver 102b indicates that the receiver 102b has registered on the application 130 in an unauthorized location (e.g., country), and 4) the current location of the user device 120b of the receiver 102b (location data 150b) is or within an unauthorized location to receive the data item 106, the approval status 154b is a warning alert and the data item transfer request 104 is to be evaluated further based on patterns of historical data item transfers by the particular sender 102a, receiver 102b, and training dataset 182, e.g., by the deep learning algorithm 180.

In another example, the n-th row in the table 156 shown in FIG. 1 may indicate an n-th rule 142 that if 1) the onboarding location data 144n associated with the sender 102a indicates that the sender 102a has registered on the application 130 in an unauthorized location (e.g., country), 2) the current location of the user device 120a of the sender 102a (i.e., location data 146n) is or within an unauthorized location to make the transfer, 3) the onboarding location data 148n associated with the receiver 102b indicates that the receiver 102b has registered on the application 130 in an unauthorized location (e.g., country), and 4) the current location of the user device 120b of the receiver 102b (location data 150n) is or within an unauthorized location to receive the data item 106, the data item transfer request 104 is to be denied (as indicated by the approval status 154n). Other circumstances and combinations of the location data 144, 146, 146, and 150 are also possible, some of which are described further below in conjunction with FIG. 2.

### Example Distributed Network

In some embodiments, the distributed network 170 may be or include a blockchain network of multiple nodes 160. In some embodiments, the distributed network 170 may be or include multiple blockchain networks of nodes 160. The distributed network 170 may represent a decentralized network of nodes 160 that are configured to evaluate each data item transfer request 104 based on location data 144, 146, 148, and 150, the training dataset 182, the rules 142, the historical patterns of transfer requests 104, among other information.

The distributed network 170 may include a set of nodes 160. Each node 160 may be a network node, a computing device, a virtual machine, and the like. For example, the node 160 may include a hardware computer system configured to determine process, analyze, and evaluate each data item transfer request 104. In certain embodiments, the distributed network 170 may be implemented by a cluster of computing devices, such as virtual machines as nodes 160a-n. For example, the distributed network 170 may be implemented by a plurality of computing devices using distributed computing and/or cloud computing systems in a network. In certain embodiments, the distributed network 170 may be configured to provide services and resources (e.g., the decision on granting or denying a data transfer request 104) to other components and devices.

Each node 160a-n may be an instance of a node 160. Each node 160 includes a processor 162 in signal communication with a network interface 164 and a memory 166. Memory 166 stores software instructions 168 that when executed by the processor 162 cause the processor 162 to perform one or more operations of the respective node 160a-n. Processor 162 comprises one or more processors. The processor 162 is any electronic circuitry, including, but not limited to, state machines, one or more CPU chips, logic units, cores (e.g., a multi-core processor), FPGAs, ASICS, or DSPs. For example, one or more processors may be implemented in cloud devices, servers, virtual machines, and the like. The processor 162 may be a programmable logic device, a microcontroller, a microprocessor, or any suitable number and combination of the preceding. The one or more processors are configured to process data and may be implemented in hardware or software. For example, the processor 162 may be 8-bit, 16-bit, 32-bit, 64-bit, or of any other suitable architecture. The processor 162 may include an ALU for performing arithmetic and logic operations. The processor 162 may register the supply operands to the ALU and store the results of ALU operations. The processor 162 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 168) to perform the operations of the node 160 described herein. In this way, processor 162 may be a special-purpose computer designed to implement the functions disclosed herein. In an embodiment, the processor 162 is implemented using logic units, FPGAs, ASICS, DSPs, or any other suitable hardware. The processor 162 is configured to operate as described in FIGS. 1-3. For example, the processor 162 may be configured to perform one or more operations of the operational flow 200 as described in FIG. 2 and one or more operations of the method 300 as described in FIG. 3.

Network interface 164 is configured to enable wired and/or wireless communications. The network interface 164 may be configured to communicate data between the node 160 and other devices, systems, or domains. For example, the network interface 164 may comprise an NFC interface, a Bluetooth interface, a Zigbee interface, a Z-wave interface, a RFID interface, a WIFI interface, a LAN interface, a WAN interface, a MAN interface, a PAN interface, a WPAN interface, a modem, a switch, and/or a router. The processor 162 may be configured to send and receive data using the network interface 164. The network interface 164 may be configured to use any suitable type of communication protocol.

The memory 166 may be a non-transitory computer-readable medium. The memory 166 may be volatile or non-volatile and may comprise ROM, RAM, TCAM, DRAM, and/or SRAM. The memory 166 may include one or more of a local database, a cloud database, a NAS, etc. The memory 166 comprises one or more disks, tape drives, or solid-state drives, and may be used as an over-flow data storage device, to store programs when such programs are selected for execution, and to store instructions and data that are read during program execution. The memory 166 may store any of the information described in FIGS. 1-3 along with any other data, instructions, logic, rules, or code operable to implement the function(s) described herein when executed by processor 162. For example, the memory 166 may store software instructions 168, smart contract generation engine 184, smart contracts 186, deep learning algorithm 180, training dataset 182, rules 142, API calls 210a-d, API responses 212a-d, feature vectors 220 and 226, and/or any other data or instructions. The software instructions 168 may comprise any suitable set of instructions, logic, rules, or code operable to execute the processor 162 and perform the functions described herein, such as some or all of those described in FIGS. 1-3.

The smart contract generator engine 184 may be implemented by the processor 162 executing the software instructions 168 and is generally configured to generate smart contracts 186 based on the location data 144, 146, 148, and 148, the unique identifier (ID) 152 of the transfer request 104, identifier of the data item 106 that is requested to be transferred, information about the sender 102a and information about the receiver 102b, among other information described herein. For example, the user 102a, using the user device 120a, sends the request 104, indicating that they want to transfer or transmit the data item 106 to the distributed network 170. In response, the smart contract generation engine 184 (in one or more nodes 160) may process the request 104 and generate a smart contract 186 for the request 104.

The smart contract 186 may be a self-executing contract where the terms of the agreement between the users 102a-b and location data 144, 146, 148, and 148, the unique identifier (ID) 152 of the transfer request 104, identifier of the data item 106 that is requested to be transferred, information about the sender 102a and information about the receiver 102b, among other information are written into lines of code. In some embodiments, the smart contract 186 may be run on a blockchain, which is a distributed and decentralized digital database, such as the distributed network 170. The code in smart contract 186 may contain a set of location data 144, 146, 148, and 148 that, when evaluated and determined to comply with the rules 142, automatically executes the smart contract 186. In this manner, the smart contract 186b are used to achieve consensus about the status of the smart contract 186, validity of the source and destination of the data transfer, and trust between the users 102a-b.

The deep learning algorithm 180 may be implemented by the processor 162 executing software instructions 168 and is generally configured to evaluate data item transfer requests 104 based on location data 144, 146, 148, and 150, rules 142, patterns of historical transfer requests, and the training dataset 182. In certain embodiments, the deep learning algorithm 180 may include a support vector machine, neural network, random forest, k-means clustering, Tree-based algorithm, Random Forest algorithm, etc. In certain embodiments, the deep learning algorithm 180 may be implemented by a plurality of neural network layers, convolutional neural network layers, Long-Short-Term-Memory (LSTM) layers, Bi-directional LSTM layers, recurrent neural network layers, and the like. The deep learning algorithm 180 may be configured to be implemented by unsupervised, semi-supervised, and/or supervised machine learning algorithms. For example, the deep learning algorithm 180 may be pre-trained based on training dataset 182.

For example, in the training stage, the deep learning algorithm 180 may be given the training dataset 182 that includes a set of historical data item transfers, where each of them is labeled with a respective approval status 154 which may be granted, denied, or a warning indication. Each historical data item transfer is associated and/or accompanied by the respective location data 144, 146, 148, and 148, ID 152, and approval status 154. The deep learning algorithm 180 may extract a set of features from each historical data item transfer and learn the associations between the historical data item transfer, its label, and the extracted features. The extracted features may represent the location data 144, 146, 148, and 148, ID 152, and approval status 154, among others. The extracted features may be represented by a first feature vector.

In the testing stage, the deep learning algorithm 180 may be given a data item transfer request 104 that is not labeled with an indication of approval status 154 and is asked to predict whether the data item transfer request 104 should be granted or denied. The deep learning algorithm 180 may extract a set of features from the testing data item transfer request 104 and identify the location data 144, 146, 148, and 148, the amount of the data item 106, etc. The extracted features may be represented by a second feature vector.

The deep learning algorithm 180 may compare the first feature vector with the second feature vector. If the deep learning algorithm 180 determines that the first feature vector corresponds to the second feature vector, the deep learning algorithm 180 may determine that the testing data item transfer request 104 should have the same granted, denied, or warning indication as the labeled historical data item transfer request 104.

### Example Operational Flow for Implementing Location-Based Validation in Data Item Transfer Approval Process

FIG. 2 illustrates an example operational flow 200 of the system 100 of FIG. 1 for implementing location-based validation in data item transfer approval process. In operation, the operational flow 200 of the system 100 may begin when the user or sender 102a initiates a request 104 to transfer the data item 106 to another user 102b. For example, the user 102a may log into the application 130 and on the user device 120a and request to transfer the data item 106. In response, the user device 120a sends the request 104 to the distributed network 170. The request 104 may include information about the sender 102a, such as name, address, unique identifier, etc., information about the receiver 102b, such as name, address, unique identifier, and the amount of the data item 106, among other information. The request 104 may be forwarded to one or more node 160. The node 160 may receive and analyze the request 104.

Determining Location Data Associated with the Sender and Receiver

The node 160 may determine whether the source and destination of the data item 106 are valid and authorized to send and receive the data item 106, respectively. To this end, in some embodiments, the node 160 may determine the location data 144 and 146 associated with the sender 102a and the location data 148 and 150 associated with the receiver 102b. In this process, for example, the node 160 may communicate a first API call or request 210a to the user device 120a, requesting to provide the onboarding location where the sender 102a has registered and opened a profile at the software application 130.

In response, the user device 120a may determine the onboarding location data 144 based on the record of where the sender 102a has registered and opened a profile at the software application 130, e.g., determined by a location sensor of the user device 120a. The user device 120a may communicate an API response 212a that includes the onboarding location data 144 to the node 160. The location data 144 may include the longitude and latitude coordinates of the onboarding location of the user 102a at the time where the sender 102a has registered and opened a profile at the software application 130.

To determine the current location of the sender 102a and user device 120a, the node 160 may communicate a second API call or request 210b to the user device 120a, requesting to provide the current location of the user device 120a. In response, the user device 120a may communicate its current location coordinates as location data 146 in an API response 212b to the node 160. The location data 146 may include the current longitude and latitude location coordinates of the user device 120a. The location data 146 may optionally include the timestamp of the transfer request 104.

To determine the onboarding location of the user 102b, the node 160 may first identify the user device 120b. For example, the node 160 may identify the user device 120b based on information associated with the user 102b and user device 120b in the request 104. For example, the request 104 may include a profile or identifier of the user 102b which can be traced back to the user 102a and/or user device 120b of the user 102b where the application 130 is installed or accessed. In some embodiments, the identifier may include or be associated with an internet protocol (IP) address of the user device 120b. In response to identifying the user device 120b, the node 160 may communicate an API call 210c to the user device 120b, requesting to provide a location where the user 102b has registered and opened an account in the software application 130. In response, the user device 120b may determine the onboarding location data 148 based on the historical record of where the user 102b has registered and opened a profile at the software application 130, e.g., determined by a location sensor of the user device 120b. The user device 120b may communicate an API response 212c that includes the onboarding location data 148 to the node 160. The location data 148 may include the longitude and latitude coordinates of the onboarding location of the user 102b at the time when the user 102b has registered and opened a profile at the software application 130.

To determine the current location of the user 102b and user device 120b, the node 160 may communicate an API call or request 210d to the user device 120b, requesting to provide the current location of the user device 120b. In response, the user device 120b may communicate its current location coordinates as location data 150 in an API response 212d to the node 160. The location data 150 may include the current longitude and latitude location coordinates of the user device 120a.

In some embodiments, the node 160 may reduce the number of API calls 210a-d to preserve network resources and reduce network congestion at the node 160 and user devices 120a-b. For example, the node 160 may communicate a single API call 210 to the user device 120a, requesting to provide location data 144 and 146. In response, the user device 120a may communicate a single API response 212 that includes the location data 144 and 146 to the node 160. Similarly, the node 160 may communicate a single API call 210 to the user device 120b, requesting to provide the location data 148 and 150. In response, the user device 120b may communicate a single API response 212 that includes the location data 148 and 150 to the node 160.

### Evaluating the Data Item Transfer Request Based on the Location Data

The node 160 may feed the received location data 144, 146, 148, and 150 and other information associated with the request 104 to the smart contract generating engine 184. The smart contract generation engine 184 may generate a smart contract 186 that includes pieces of code and/or numbers indicating the location data 144, 146, 148, and 150, the ID 152, an amount of the data item 106, among other information. The ID 152 may be a unique identifier assigned to the transfer request 104 by the smart contract generation engine 184. The smart contract 186 may include other information described in FIG. 1.

In response to generating the smart contract 186, the node 160 determines whether the transfer request 104 should be allowed, denied, or needs further evaluation. To this end, the node 160 feeds the smart contract 186 along with the transfer request 104 to the deep learning algorithm 180. The deep learning algorithm 180 determines whether the request 104 is anomalous based on the training dataset 182 and rules 142. In this process, the deep learning algorithm 180 may extract features 214 from the request 104 and smart contract 186, where the features 214 may indicate the location data 144, 146, 148, and 150, ID 152, the amount of the data item 106, etc. The features 214 may be represented by the feature vector 216 which includes numerical values. The deep learning algorithm 180 performs a similar operation for each data in the training dataset 182. For example, the deep learning algorithm 180 may extract features 218 from each historical data request in the training dataset 182, wherein the features 218 may indicate the location data 144, 146, 148, and 159, ID 152, and approval status 154 of the respective historical data request. The features 218 may be represented by the feature vector 220 which comprises numerical values.

The deep learning algorithm 180 may compare the feature vector 216 with the feature vector 220 and determine whether they correspond to each other and have corresponding features. In this process, in some embodiments, the deep learning algorithm 180 may determine the Euclidean distance between the feature vectors 216 and 220. If the Euclidean distance is less than a threshold distance (e.g., less than 0.1 centimeters (cm), 0.2, etc.), the deep learning algorithm 180 may determine that the request 104 should have the same approval status 154 as the historical transfer request from which the features 218 are extracted.

In some embodiments, the deep learning algorithm 180 may further follow the rules 142 in determining whether the request 104 should have the same approval status 154 as a particular entry in the table of rules 142 from which the features 218 are extracted. In some embodiments, the rules 142 may be included in the training dataset 182. In response to determining the approval status 154 of the request 104 (that corresponds to the approval status 154 of the historical transfer request and the particular entry in the table of rules 142), the node 160 may evaluate each case of the approval status 154.

In case the approval status 154 is an approved indication, the node 160 may approve the request 104. In response, the node 160 may determine that the request 104 is not anomalous based on the training dataset 182 and the rules 142. In some embodiments, determining that the request 104 is not anomalous comprises identifying a rule 142 that indicates senders associated with the location data 144 and 146 are allowed to transfer data items 106 to receivers associated with the location data 148 and 150.

In some embodiments, determining that the request 104 is not anomalous comprises determining that the location data 144, 146, 148, and 150 are associated with approved historical data item transfers as indicated by the training dataset 182 and the rule 142. If it is determined that the approval status 154 is approved, the node 160 may approve the request 104 and allow the transfer of the data item 106 from the profile of the user 102a to the profile of the user 102b.

In case the approval status 154 is a denied indication, the node 160 may deny the request 104. In response, the node 160 may determine that the request 104 is anomalous based on the training dataset 182 and the rules 142. In some embodiments, the node 160 may determine that the request 104 is anomalous based on the training dataset 182 and the rules 142. For example, in some embodiments, determining that the request 104 is anomalous comprises determining that the location data 144 and 146 are associated with denied historical data item transfers and the location data 148 and 150 are associated with approved historical data item transfers as indicated by the training dataset 182 and the rule 142. In another example, in some embodiments, determining that the request 104 is anomalous comprises determining that the location data 144 and 146 are associated with approved historical data item transfers and the location data 148 and 150 are associated with denied historical data item transfers as indicated by the training dataset 182 and the rule 142.

In some embodiments, the node 160 may determine that the request 104 is anomalous based on the training dataset 182 and the rules 142. For example, in some embodiments, determining that the request 104 is anomalous comprises determining that the location data 144, 146, 148, and 150 are associated with denied historical data item transfers as indicated by the training dataset 182 and the rule 142. If it is determined that the approval status 154 is denied, the node 160 may deny the request 104.

In case it is determined that the approval status 154 is neither approved nor denied (e.g., the approval status 154 is a warning alert indicating that it is not yet clear whether the request 104 should be denied or approved), the node 160 may determine that the request 104 needs further evaluation. In some embodiments, the node 160 may determine that the approval status 154 of the request 104 is neither approved nor denied (e.g., a warning alert or is a gray area). For example, in some embodiments, determining that the request 104 is a warning alert comprises determining that the location data 144 associated with the user 102a is an authorized location, the location data 146 associated with the user 102a is an unauthorized location, the location data 148 associated with the user 102b is an unauthorized location, and the location data 150 associated with the user 102b is associated with an authorized location as indicated by the training dataset 182 and the rule 142.

For example, in this process, the node 160 may determine the pattern of the previous requests 104 initiated by the user 102a and determine whether the pattern of previous request 104 indicates that the request 104 is anomalous. For example, anomalous patterns of historical/previous requests 104 may comprise repetitive data item transfer requests in a less than a threshold period of time, transferring more than a threshold amount of data items 106 in a less than a threshold period of time, among others. The set of rules 142 may include criteria for identifying such anomalous patterns in the historical data item transfers.

In some embodiments, a location data 144, 146, 148, 150 may be an unauthorized location to send or receive data item 106 if the location data is or within a location that is under data item transfer regulatory constraints (such as sanctions put on certain countries). After further evaluation based on the pattern of the historical/previous data item transfer requests 104 from the user 102a, the node 160 may determine whether the approval status 154 of the request 104 should be approved or denied. In response, the node 160 may approve or deny the request 104 according to the determined approval status 154. The node 160 may communicate the data item 106 from the profile of the user 102a to the profile of the user 102b if the approval status 154 of the transfer request 104 is an approved indication. If the approval status 154 of the transfer request 104 is a denied indication, the node 160 may prevent the transfer of the data item 106 from the profile of the user 102a to the profile of the user 102b.

### Example Method for Implementing Location-Based Validation in Data Item Transfer Approval Process

FIG. 3 illustrates an example flowchart of a method 300 for implementing location-based validation in the data item transfer approval process, according to some embodiments. Modifications, additions, or omissions may be made to method 300. Method 300 may include more, fewer, or other operations. For example, operations may be performed in parallel or in any suitable order. While at times it is discussed that the system 100, user devices 120a,b, nodes 160a-n, network 170, or components of any of thereof perform some operations, any suitable system or components of the system may perform one or more operations of the method 300. For example, one or more operations of method 300 may be implemented, at least in part, in the form of software instructions 128a, 128b, 168 of FIG. 1, stored on a tangible non-transitory machine-readable medium (e.g., memory 126a, 126b, 166 of FIG. 1) that when run by one or more processors (e.g., processor 122a, 122b, 162 of FIG. 1) may cause the one or more processors to perform operations 302-320.

At operation 302, the node 160 receives a request 104 that indicates to transfer a data item 106. For example, the node 160 may receive the request 104 from the user device 120a when the user 102a initiates the request 104, similar to that described in FIG. 2.

At operation 304, the node 160 determines a first location data 144 associated with the sender 102a of the data item 106, where the first location data 144 indicates a location where the sender 102a is registered to the software application 130 configured to transfer the data item 106. The node 160 may determine the location data 144 by communicating the API call 210a to the user device 120a and receiving API response 212a from the user device 120a, similar to that described in FIG. 2. In some embodiments, the location data 144 may indicate a country that the sender 102a is from or the nationality of the sender 102a.

At operation 306, the node 160 determines a second location data 146 associated with the sender 102a of the data item 106, where the second location data 146 indicates a current location of the user device 120a of the sender 102a from which the request 104 is received. For example, the node 160 may determine the location data 146 by communicating the API call 210b to the user device 120a and receiving the API response 212b from the user device 120a, similar to that described in FIG. 2.

At operation 308, the node 160 determines a third location data 148 associated with the receiver 102b of the data item 106, where the location data 148 indicates a location where the receiver 102b is registered to the software application 130. For example, the node 160 may determine the location data 148 by communicating the API call 210c to the user device 120b and receiving the API response 212c from the user device 120b, similar to that described in FIG. 2. In some embodiments, the location data 148 may indicate a country that the receiver 102b is from or the nationality of the receiver 102b.

At operation 310, the node 160 determines a fourth location data 150 associated with the receiver 102b of the data item 106, where the location data 150 indicates a current location of the user device 120b of the receiver 102b. For example, the node 160 may determine the location data 150 by communicating the API call 210d to the user device 120b and receiving the API response 212d from the user device 120b, similar to that described in FIG. 2.

At operation 312, the node 160 determines what is the approval status 154 of the transfer request 104. For example, the node 160 may feed the location data 144, 146, 148, and 150, the request 104, and other information about the request 104 to the deep learning algorithm 180. The deep learning algorithm 180 predicts the approval status 154 of the request 104 based on the rules 142 and the training dataset 182, similar to that described in FIG. 2. If it is determined that the approval status 154 is a denied indication, the method 300 proceeds to operation 320. If it is determined that the approval status 154 is an approved indication, the method 300 proceeds to operation 318. If it is determined that the approval status 154 is a warning alert, the method 300 proceeds to operation 314.

At operation 314, the node 160 evaluates the request 104 based on historical transfer requests 104 associated with the sender 102a. In this process, the node 160 determines the pattern of the historical/previous transfer requests 104 from the sender 102a and determines whether the determined pattern is anomalous, similar to that described in FIG. 2.

At operation 316, the node 160 determines whether the request 104 is anomalous, for example, based on the rules 142, training dataset 182, historical transfer requests 104 from the sender 102a, and/or historical transfers to the receiver 102b. For example, if it is determined that the pattern of the historical transfer requests 104 from the sender 102a is anomalous, the node 160 determines that the request 104 is anomalous. In another example, if it is determined that the pattern of the historical transfers to the receiver 102b is anomalous, the node 160 determines that the request 104 is anomalous. If it is determined that the request 104 is anomalous, the method 300 proceeds to operation 320. Otherwise, the method 300 proceeds to operation 318.

At operation 318, the node 160 grants the request 104. In other words, the node 160 grants the request of the sender 102a to transfer the data item 106 to the receiver 102b. In response, the node 160 may facilitate the transfer of the data item 106 from the profile of the sender 102a to the profile of the receiver 102b. For example, the node 160 may communicate the data item 106 from the profile of the sender 102a to the profile of the receiver 102b. A operation 320, the node 160 denies the request 104. In other words, the node 160 does not allow the transfer of the data item 106.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system for implementing location-based validation in data item transfer approval process, comprising:
a memory configured to store:
a training dataset that comprises a set of historical data item transfers, each of the set of historical data item transfers is labeled with a granted or denied indication; and
a set of rules, each of the set of rules indicates a circumstance that a data item transfer request is be approved or denied based at least in part upon location data associated with a sender and a receiver of a respective data item; and
a processor, operably coupled to the memory and configured to:
receive a request message that indicates to transfer a data item;
determine a first location data associated with a sender of the data item, wherein the first location data indicates a location where the sender is registered to a software application that is configured to facilitate transferring the data item;
determine a second location data associated with the sender of the data item, wherein the second location data indicates a current location of a first user device from which the request message is received;
determine a third location data associated with a receiver of the data item, wherein the third location data indicates a location where the receiver has registered to the software application;
determine a fourth location data associated with the receiver of the data item, wherein the fourth location data indicates a current location of a second user device associated with the receiver;
determine whether the request message is anomalous based at least in part upon the training dataset and the set of rules; and
in response to determining that the request message is not anomalous, grant the request message.

2. The system of claim 1, wherein determining that the request message is not anomalous based at least in part upon the training dataset and the set of rules comprises identifying a rule, from among the set of rules, that indicates senders associated with the first location data and the second location data are allowed to transfer data items to receivers associated with the third location data and the fourth location data.

3. The system of claim 1, wherein determining that the request message is not anomalous based at least in part upon the training dataset and the set of rules comprises:
determining that the first location data is associated with approved historical data item transfers;
determining that the second location data is associated with approved historical data item transfers;
determining that the third location data is associated with approved historical data item transfers; and
determining that the fourth location data is associated with approved historical data item transfers.

4. The system of claim 1, wherein the processor is further configured to determine that the request message is anomalous based at least in part upon the training dataset and the set of rules, comprising:
determining that the first location data is associated with approved historical data item transfers;
determining that the second location data is associated with approved historical data item transfers;
determining that the third location data is associated with denied historical data item transfers; and
determining that the fourth location data is associated with denied historical data item transfers.

5. The system of claim 1, wherein the processor is further configured to determine that the request message is anomalous based at least in part upon the training dataset and the set of rules, comprising:
determining that the first location data is associated with denied historical data item transfers;
determining that the second location data is associated with denied historical data item transfers;
determining that the third location data is associated with approved historical data item transfers; and
determining that the fourth location data is associated with approved historical data item transfers.

6. The system of claim 1, wherein the processor is further configured to determine that the request message is anomalous based at least in part upon the training dataset and the set of rules, comprising:
determining that the first location data is associated with denied historical data item transfers;
determining that the second location data is associated with denied historical data item transfers;
determining that the third location data is associated with denied historical data item transfers; and
determining that the fourth location data is associated with denied historical data item transfers.

7. The system of claim 1, wherein:
determining the first location data is in response to communicating a first application programming interface (API) call to the first user device, wherein the first API call indicates to provide the location where the sender has registered to the software application;
determining the second location data is in response to communicating a second API call to the first user device, wherein the second API call indicates to provide a current location of the first user device;
determining the third location data is in response to communicating a third API call to the second user device, wherein the third API call indicates to provide a location where the receiver has registered to the software application; and
determining the fourth location data is in response to communicating a fourth API call to the second user device, wherein the fourth API call indicates to provide a current location of the second user device.

8. A method for implementing location-based validation in data item transfer approval process, comprising:
storing a training dataset that comprises a set of historical data item transfers, each of the set of historical data item transfers is labeled with a granted or denied indication;
storing a set of rules, each of the set of rules indicates a circumstance that a data item transfer request is to be approved or denied based at least in part upon location data associated with a sender and a receiver of a respective data item;
receiving a request message that indicates to transfer a data item;
determining a first location data associated with a sender of the data item, wherein the first location data indicates a location where the sender is registered to a software application that is configured to facilitate transferring the data item;
determining a second location data associated with the sender of the data item, wherein the second location data indicates a current location of a first user device from which the request message is received;
determining a third location data associated with a receiver of the data item, wherein the third location data indicates a location where the receiver has registered to the software application;
determining a fourth location data associated with the receiver of the data item, wherein the fourth location data indicates a current location of a second user device associated with the receiver;
determining whether the request message is anomalous based at least in part upon the training dataset and the set of rules; and
in response to determining that the request message is not anomalous, granting the request message.

9. The method of claim 8, wherein determining that the request message is not anomalous based at least in part upon the training dataset and the set of rules comprises identifying a rule, from among the set of rules, that indicates senders associated with the first location data and the second location data are allowed to transfer data items to receivers associated with the third location data and the fourth location data.

10. The method of claim 8, wherein determining that the request message is not anomalous based at least in part upon the training dataset and the set of rules comprises:
determining that the first location data is associated with approved historical data item transfers;
determining that the second location data is associated with approved historical data item transfers;
determining that the third location data is associated with approved historical data item transfers; and
determining that the fourth location data is associated with approved historical data item transfers.

11. The method of claim 8, further comprising determining that the request message is anomalous based at least in part upon the training dataset and the set of rules, comprising:
determining that the first location data is associated with approved historical data item transfers;
determining that the second location data is associated with approved historical data item transfers;
determining that the third location data is associated with denied historical data item transfers; and
determining that the fourth location data is associated with denied historical data item transfers.

12. The method of claim 8, further comprising determining that the request message is anomalous based at least in part upon the training dataset and the set of rules, comprising:
determining that the first location data is associated with denied historical data item transfers;
determining that the second location data is associated with denied historical data item transfers;
determining that the third location data is associated with approved historical data item transfers; and
determining that the fourth location data is associated with approved historical data item transfers.

13. The method of claim 8, further comprising determining that the request message is anomalous based at least in part upon the training dataset and the set of rules, comprising:
determining that the first location data is associated with denied historical data item transfers;
determining that the second location data is associated with denied historical data item transfers;
determining that the third location data is associated with denied historical data item transfers; and
determining that the fourth location data is associated with denied historical data item transfers.

14. The method of claim 8, wherein the set of rules comprises a criteria for identifying one or more anomalous patterns in the set of historical data item transfers, wherein the one or more anomalous patterns comprise repetitive data item transfer requests or transferring a more than threshold amount of data items in a less than a threshold period of time.

15. A non-transitory computer-readable medium storing instructions that when executed by a processor, cause the processor to:
store a training dataset that comprises a set of historical data item transfers, each of the set of historical data item transfers is labeled with a granted or denied indication;
store a set of rules, each of the set of rules indicates a circumstance that a data item transfer request is to be approved or denied based at least in part upon location data associated with a sender and a receiver of a respective data item;
receive a request message that indicates to transfer a data item;
determine a first location data associated with a sender of the data item, wherein the first location data indicates a location where the sender is registered to a software application that is configured to facilitate transferring the data item;
determine a second location data associated with the sender of the data item, wherein the second location data indicates a current location of a first user device from which the request message is received;
determine a third location data associated with a receiver of the data item, wherein the third location data indicates a location where the receiver has registered to the software application;
determine a fourth location data associated with the receiver of the data item, wherein the fourth location data indicates a current location of a second user device associated with the receiver;
determine whether the request message is anomalous based at least in part upon the training dataset and the set of rules; and
in response to determining that the request message is not anomalous, grant the request message.

16. The non-transitory computer-readable medium of claim 15, wherein determining that the request message is not anomalous based at least in part upon the training dataset and the set of rules comprises identifying a rule, from among the set of rules, that indicates senders associated with the first location data and the second location data are allowed to transfer data items to receivers associated with the third location data and the fourth location data.

17. The non-transitory computer-readable medium of claim 15, wherein determining that the request message is not anomalous based at least in part upon the training dataset and the set of rules comprises:
determining that the first location data is associated with approved historical data item transfers;
determining that the second location data is associated with approved historical data item transfers;
determining that the third location data is associated with approved historical data item transfers; and
determining that the fourth location data is associated with approved historical data item transfers.

18. The non-transitory computer-readable medium of claim 15, wherein the instructions further cause the processor to determine that the request message is anomalous based at least in part upon the training dataset and the set of rules, comprising:
determining that the first location data is associated with approved historical data item transfers;
determining that the second location data is associated with approved historical data item transfers;
determining that the third location data is associated with denied historical data item transfers; and
determining that the fourth location data is associated with denied historical data item transfers.

19. The non-transitory computer-readable medium of claim 15, wherein the instructions further cause the processor to determine that the request message is anomalous based at least in part upon the training dataset and the set of rules, comprising:
determining that the first location data is associated with denied historical data item transfers;
determining that the second location data is associated with denied historical data item transfers;
determining that the third location data is associated with approved historical data item transfers; and
determining that the fourth location data is associated with approved historical data item transfers.

20. The non-transitory computer-readable medium of claim 15, wherein the instructions further cause the processor to determine that the request message is anomalous based at least in part upon the training dataset and the set of rules, comprising:
determining that the first location data is associated with denied historical data item transfers;
determining that the second location data is associated with denied historical data item transfers;
determining that the third location data is associated with denied historical data item transfers; and
determining that the fourth location data is associated with denied historical data item transfers.
